(19) United States
(12) Patent Application Publication
(10) Pub. No.: US 2026/0178495 A1
(43) Pub. Date: Jun. 25, 2026

(54) Last-Level-Cache-Aware Reader-Writer Semaphore

(71) Applicant: Advanced Micro Devices, Inc., Santa Clara, CA (US)

(72) Inventors: Ranjal Gautham Shenoy, Bangalore (IN); Neeraj Upadhyay, Bangalore (IN)

(73) Assignee: Advanced Micro Devices, Inc., Santa Clara, CA (US)

(21) Appl. No.: 18/988,556

(22) Filed: Dec. 19, 2024

(51) Int. Cl. G06F 12/0811

(52) U.S. Cl. CPC G06F 12/0811

(57) ABSTRACT

Systems and techniques for last-level-cache-aware reader-writer semaphore are described. In one example, a processor includes a cache system and a semaphore associated with a last-level shared cache of the cache system. The semaphore includes multiple local counters that are each associated with a domain of multiple domains. Each local counter includes a reader counter and a writer-presence bit. The semaphore also includes a global counter that includes a global reader counter. In response to receiving a read lock request, the semaphore increments the reader counter of the corresponding local counter if the writer-presence bit is not set. In response to receiving a write lock request, the semaphore is configured to set the writer-presence bit of the multiple local counters, set the global reader counter to a sum of the reader counter of the multiple local counters, and acquire the write lock once the global reader counter is equal to zero.

### BACKGROUND

Multi-tasking systems use semaphores to ensure multiple processes or threads can access shared objects in a coordinated manner to prevent data corruption and inconsistencies. As the quality-of-service (QoS), latency, and throughput requirements increase for many applications, systems running these applications utilize multiple processors with multiple cache and non-uniform memory access (NUMA) domains. Because operations on shared data are a primary impediment to improving scalability, systems are adopting a divide-and-conquer approach to split and offload workload streams to different threads and running the threads on different processors in parallel. However, when multiple requests try to acquire the semaphore simultaneously, the latency of traditional lock operations for semaphores significantly impacts the scalability of parallel requests.

### BRIEF DESCRIPTION OF THE DRAWINGS

The detailed description is described with reference to the accompanying figures.

FIG. 1 depicts a block diagram of a processing system configured to execute one or more applications in accordance with one or more implementations.

FIG. 2 is a block diagram of a non-limiting example system to implement a last-level-cache (LLC)-aware reader-writer semaphore.

FIG. 3 depicts an example of a global counter and LLC local counters to implement an LLC-aware reader-writer semaphore in accordance with one or more implementations.

FIG. 4 depicts an example procedure for a reader lock acquisition to implement an LLC-aware reader-writer semaphore in accordance with one or more implementations.

FIG. 5 depicts an example procedure for a reader lock release to implement an LLC-aware reader-writer semaphore in accordance with one or more implementations.

FIG. 6 depicts an example procedure for a writer lock acquisition to implement an LLC-aware reader-writer semaphore in accordance with one or more implementations.

FIG. 7 depicts an example procedure for a writer lock release to implement an LLC-aware reader-writer semaphore in accordance with one or more implementations.

### DETAILED DESCRIPTION

### Overview

An example system includes multiple processors or systems on a chip (SoCs), each with one or more processor cores communicatively coupled to a memory system with volatile and non-volatile memory. The system includes a cache system with multiple cache levels. For example, the cache system includes level one caches and level two caches that are private to respective cores and a last level cache (LLC) that is shared among the multiple cores of the processor.

Operations on shared data in memory are broadly categorized as read operations and write operations. Read operations (e.g., listing files in a directory or reading a data structure’s content) are concurrently executable without a change to the state of the shared data. However, to ensure data consistency, write operations (e.g., file renames or data write operations) are not executable concurrently with other read or write access requests. In other words, write operations utilize mutual exclusion from other access requests to the shared data. System software implements locking primitives such as read_lock(), read_trylock(), or write_lock() to enforce mutual exclusion operations.

As the number of processor cores increases, the QoS, latency, and throughput requirements for many applications continue to increase. To address the increasing performance demands, systems (e.g., servers) running these applications utilize multiple processors (e.g., multiple central processing units (CPUs)) with multiple cache domains and non-uniform memory access (NUMA) domains. Because operations on shared data are a primary impediment to improving scalability, systems adopt a divide-and-conquer approach to split and offload workload streams to different processes and run the processes in parallel. However, when multiple read requests try to acquire the semaphore guarding the shared objects simultaneously, the latency of traditional lock operations for semaphores significantly impacts the scalability of parallel read requests.

Some traditional systems use a lock state variable that is generally double-word size (e.g., eight bytes). Acquire and release operations of the lock involve atomic manipulation of the lock state variable (e.g., using a read-modify-write (RmW) primitive in the instruction set architecture (ISA)). An example instruction is a locked-add (lock xadd) instruction that atomically adds to the current value at an address and returns the value at the address before the addition. Reader or writer locks segment the lock state variable into multiple state fields: reader count (e.g., the number of reader threads or processes), writer-presence bit (e.g., a flag to indicate the presence of an active writer thread), and waiters present (e.g., a flag to indicate the presence of lock waiter(s)). This segmentation ensures that each lock contender atomically observes any lock state update from a reader or a writer.

In traditional systems, a reader thread performs a locked-add instruction such as an instruction to atomically add a value to the counter while returning the original value of the counter with acquire/release memory-ordering semantics. When multiple readers try and read acquire the semaphore at the same time, the readers each perform the atomic increment operation, which results in reduced scalability due to the cache line ping-pong across multiple LLC domains. Cache access propagation delays can potentially result in very high lock acquire times for readers on remote cache or NUMA domains.

In contrast, the described techniques and systems for an LLC-aware design of reader-writer semaphores reduce contention among readers (e.g., read threads). The described techniques ensure that cache snoop propagation delays do not result in very high read lock acquire times for reader threads on different cache or NUMA domains. In particular, the reader threads can acquire a lock with a bounded worst-case wait time which is not impacted by the increase in lock contenders across different LLC domains, even as the number of parallel threads and cache domains increases.

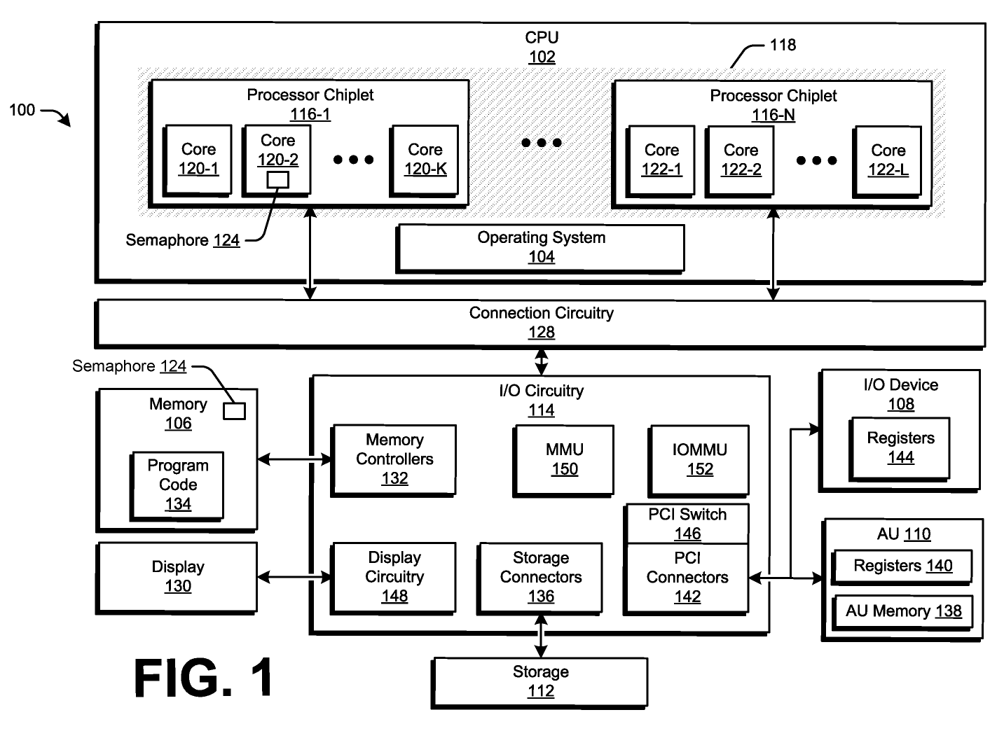

FIG. 1 is a block diagram of a processing system configured to execute one or more applications, in accordance with one or more implementations. FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include but are not limited to a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations. Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116.

Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, …, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In this example, a semaphore 124 is depicted in memory 106 with a portion thereof also depicted in the core 120-2. The semaphore 124 is implemented as software or a software artifact in memory 106. A portion of semaphore 124 (e.g., a local counter corresponding to a particular core 120, chiplet 116, or memory domain) is also included in core 120-2 as software or a software artifact. In variations, however, the semaphore 124 or a portion thereof is included in (e.g., as hardware) and/or implemented by (e.g., as software) one or more different components of the processing system 100, such as the other processor cores 120, 122, CPU 102, memory controllers 132, storage 112, the AU 110, and so forth. In at least one implementation, the semaphore 124 or portions thereof are included in at least two of the depicted components of the processing system 100 (e.g., each processor core 120, 122 and the memory 106).

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 134 (e.g., an executable file) associated with the application from, for example, a storage 112 into system memory 106. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally, or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 146 and input-output memory management unit (IOMMU) 148. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally, or alternatively, in at least one variation, the processing system 100 includes additional and/or different components from those depicted. The 100 is configurable in a variety of ways with different combinations of components in accordance with the described techniques.

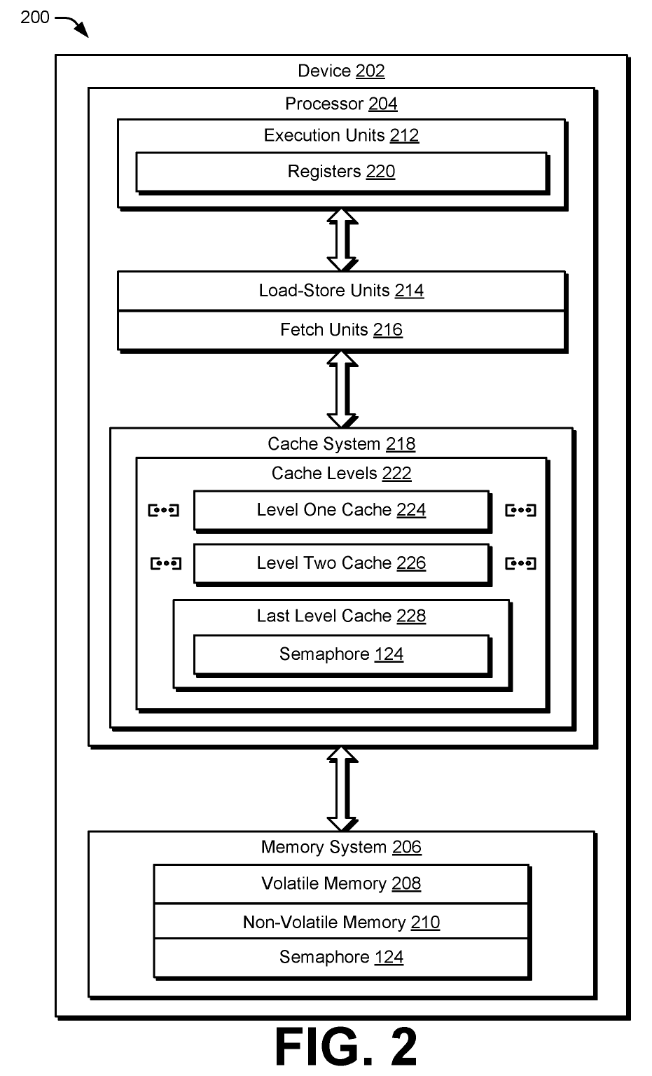

FIG. 2 is a block diagram of a non-limiting example system 200 to implement an LLC-aware reader-writer semaphore. The system 200 includes a device 202 having a processor 204 and a memory system 206, which includes volatile memory 208 and non-volatile memory 210. The device 202 is configurable in a variety of ways. Examples of the device 202 include, by way of example and not limitation, computing devices, servers, mobile devices (e.g., wearables, mobile phones, tablets, laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations. It is to be appreciated that in various implementations, the device 202 is configured as any one or more of those devices listed just above and/or a variety of other devices without departing from the spirit or scope of the described techniques.

In accordance with the described techniques, the processor 204 and the memory system 206 are coupled to one another via one or more wired and/or wireless connections. Example wired connections include, but are not limited to, buses (e.g., a data bus), interconnects, traces, and planes. The processor 204 is an electronic circuit that reads, translates, and executes workloads of a program, e.g., an application, operating system, virtual machine, container, and so on. Examples of the processor 204 include, but are not limited to including, central processing units (CPUs), graphics processing units (GPUs), Field Programmable Gate Arrays (FPGAs), Application Specific Integrated Circuits (ASICs), digital signal processors (DSPs), and accelerator devices.

The volatile memory 208 and the non-volatile memory 210 are devices and/or systems used to store information, such as for use by the processor 204. By way of example, the processor 204 includes a memory module (e.g., a Transflash memory module, a single in-line memory module (SIMM), or a dual in-line memory module (DIMM)), and the memory module is a circuit board (e.g., a printed circuit board) on which the volatile memory 208 and the non-volatile memory 210 are mounted. Further, the volatile memory 208 and the non-volatile memory 210 correspond to semiconductor memory, where data is stored within memory cells on one or more integrated circuits.

Broadly, the volatile memory 208 retains data as long as the device 202 is connected to power, and the data is accessible relatively faster than the non-volatile memory 210. Examples of volatile memory 208 include random-access memory (RAM), dynamic random-access memory (DRAM), synchronous dynamic random-access memory (SDRAM), and static random-access memory (SRAM).

The non-volatile memory 210 retains data even after the device 202 is disconnected from power, but is accessible relatively slower than the volatile memory 208. Examples of non-volatile memory include solid state disks (SSD), flash memory, read-only memory (ROM), programmable read-only memory (PROM), erasable programmable read-only memory (EPROM), and electronically erasable programmable read-only memory (EEPROM).

As shown, the processor 204 includes one or more execution units 212, one or more load-store units 214, one or more fetch units 216, and a cache system 218 coupled to one another via one or more wired and/or wireless connections. An execution unit 212 is representative of functionality implemented in hardware (e.g., electronic circuitry) of the processor 204 to perform specific types of workloads, such as arithmetic and logic operations. Further, a load-store unit 214 is representative of functionality implemented in the hardware of the processor 204 to perform load and store operations of data as part of a workload. A fetch unit 216 is representative of functionality implemented in the hardware of the processor 204 to perform load and store operations of instructions requested by a workload. The execution units 212, the load-store units 214, and the fetch units 216 perform respective operations based on requests received through the execution of software programs, e.g., applications, operating systems, virtual machines, containers, and so on. By way of example, requests are generated and forwarded to the execution units 212, the load-store units 214, and/or the fetch units 216 by a control unit (not depicted) of the processor 204.

Load requests instruct the load-store units 214 to load data from the cache system 218, the volatile memory 208, and/or the non-volatile memory 210 into registers 220 of the execution units 212. Similarly, instruction load requests instruct the fetch units 216 to load instructions from the cache system 218, the volatile memory 208, and/or the non-volatile memory 210 into registers 220 of the execution units 212. Once data is loaded into registers 220, instructions become ready to execute by the execution units 212 to perform corresponding operations according to instruction opcodes.

As illustrated, the cache system 218 includes multiple cache levels 222, including a level one cache (L1 cache) 224, which includes a level one data cache and a level one instruction cache (L1 IC), a level two cache (L2 cache) 226, and a last level cache (LLC) 228. By way of example, processor 204 is a multi-core processor, and each respective core includes the L1 cache 224 and L2 cache 226 that are exclusively used by a respective core. In some implementations, the L2 cache 226 is shared by a subset of cores. Furthermore, the processor 204 includes the LLC 228 shared among the multiple cores of the processor 204. The cache system 218 often also includes a micro-op cache (UOP cache) that stores decoded instructions in a format ready for execution.

The cache system 218 corresponds to semiconductor memory where data and instructions are stored within memory cells on one or more integrated circuits. The higher cache levels are accessible (e.g., for loading and/or storing data instructions and/or data with the L1 cache 224 and L2 cache 226) relatively faster than the lower cache levels (e.g., LLC 228). Lower cache levels in the hierarchy of cache levels generally have greater memory capacity than higher cache levels. In other implementations, the cache system 218 includes differing numbers of cache levels and different hierarchical structures without departing from the spirit or scope of the described techniques.

The cache system 218 is accessible (e.g., for loading and/or storing instructions and data) relatively faster than the memory system 206. The various memory sources of processor 204 are ordered from fastest access speed to slowest access speed in the following order: (1) L1 cache 224, (2) L2 cache 226, (3) LLC 228, (4) the volatile memory 208, and (5) the non-volatile memory 210. As a result, a load-store unit 214 executes a load request that includes a memory address by progressively checking the memory sources for the identified data in the aforementioned order. Similarly, a fetch unit 216 executes a load request that includes a memory address by progressively checking the memory sources for the identified instruction in the aforementioned order. For example, if the instruction is present in a memory source, the fetch unit 216 fetches the instruction from that memory source into the L1 IC, the processor 204 decodes the instruction and sends it to execution unit 212, where the loaded instruction waits for its operands from the load-store units 214 before being executed by execution units 212. If the instruction is not in a memory source, the fetch unit 216 checks whether the instruction is present in the next memory source.

As illustrated in FIG. 1, the memory system 206 includes a semaphore 124, which is representative of software to coordinate access among different processes and threads to shared data in the memory system 206. For example, the processor 204 (e.g., of each core of a multi-processor system) can fetch a portion (e.g., a local counter as described in greater detail below) of the semaphore 124 into the LLC 228. For example, semaphore 124 is a software artifact that monitors the access activity of the various threads and processes of the processor 204 and coordinates accesses thereof.

The semaphore 124 is used by software to enforce mutual exclusion and reduce contention among read-only threads to ensure that cache access propagation delays do not result in high read lock acquire times for threads on different cache or NUMA domains. As described above, traditional semaphore techniques use a global lock state variable to coordinate access to the shared data. Acquiring and releasing the lock involves atomic manipulation of the lock state variable. The traditional reader/writer lock technique segments the lock state variable into multiple state fields, including a read count, writer-presence bit, and waiters-presence bit. This segmentation ensures that each lock contender atomically observes a state update (e.g., from a reader or writer). However, when multiple reader threads try to acquire the semaphore concurrently, the reader threads each perform atomic increments to the read-count segment, which is inherently a serializing operation and, thus, significantly impacts the scalability of readers.

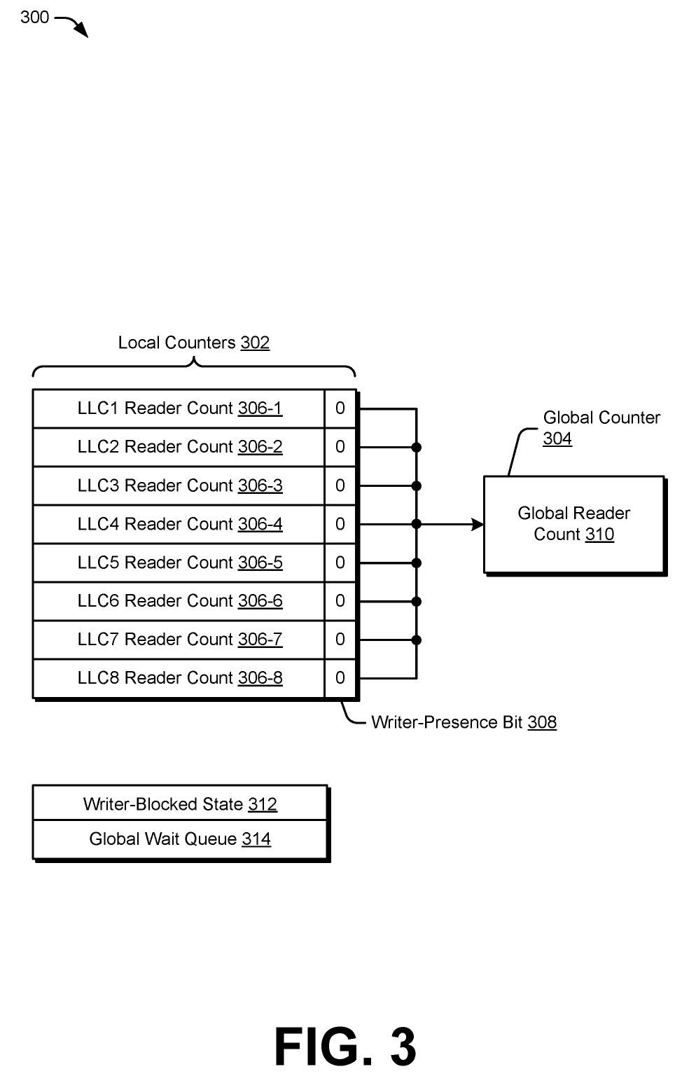

In contrast, the described techniques and systems split the management of reader counts across multiple local counters. In this way, reader threads can acquire a read lock with bounded worst-case wait times that are not impacted by an increase in the number of lock contenders across different LLC domains. The management of reader counts across local counters is described in greater detail with respect to FIG. 3.

FIG. 3 depicts an example system 300 with a global counter and local counters to implement an LLC-aware reader-writer semaphore in accordance with one or more implementations. System 300 includes local counters 302 for each chiplet 116 or processor 204, with each chiplet 116 or processor 204 having its own LLC 228. System 300 also includes a global counter 304.

Each domain (e.g., isolated regions, slices, or compartments) of the chiplets 116 or processors 204 includes a local counter 302. As illustrated, system 300 includes eight LLC domains with eight local counters 302. In one implementation, each local counter 302 has a doubleword size. Each local counter 302 includes a local reader count 306 and a writer-presence bit 308. In the illustrated example, the local reader counts 306 include LLC1 Reader Count 306-1, LLC2 Reader Count 306-2, LLC3 Reader Count 306-3, LLC4 Reader Count 306-4, LLC5 Reader Count 306-5, LLC6 Reader Count 306-6, LLC7 Reader Count 306-7, and LLC8 Reader Count 306-8.

The writer-presence bit 308 of each local counter 302 is used by a writer thread to indicate its presence. Each reader thread atomically increments the corresponding local reader count 306. If the corresponding writer-presence bit 308 is set, the reader thread atomically decrements the corresponding local reader count 306 and adds itself to a global wait queue 314.

A writer thread atomically swaps the contents of each local reader count 306 with a zero value while setting the writer-presence bit 308 on each local counter 302 in the semaphore 124. The writer thread then atomically accumulates the sum of the local reader counts 306 into a global reader count 310 of the global counter 304. Writer threads also atomically set the writer-blocked state 312 to register the writer thread as the first writer thread contending for semaphore 124. The writer thread then waits for the global reader count 310 to reach zero. Subsequent reader and writer threads are assigned to and wait their turn in the global wait queue 314.

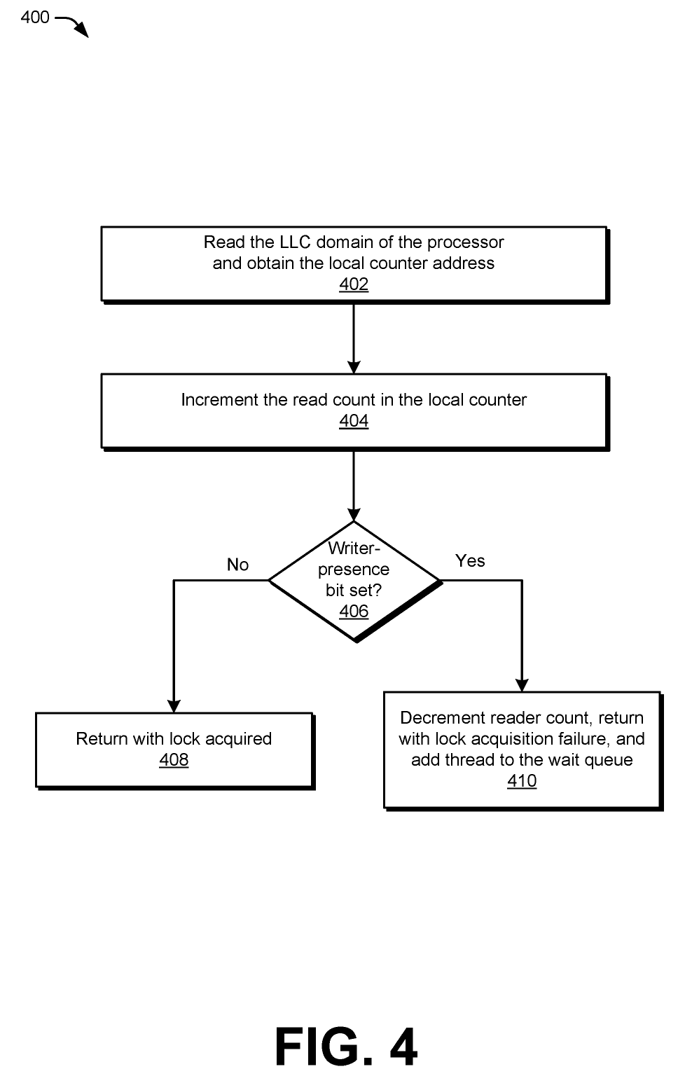

Writer threads clear the writer-presence bit 308 on each local counter 302 upon semaphore release and wake up waiters in the global wait queue 314. Each local counter 302 is atomically updated. FIGS. 4 through 7 illustrate example procedures for implementing the local counters 302 and global counter 304 of the described semaphore 124.

FIG. 4 depicts an example procedure 400 for a reader lock acquisition to implement an LLC-aware reader-writer semaphore in accordance with one or more implementations.

For a reader thread to acquire the semaphore, a semaphore reads the LLC domain of the processor or core that the reader thread is running on and obtains the local counter address (block 402). For example, reader thread acquiring the semaphore 124 disables preemption and determines an LLC or NUMA domain associated with the reader thread to associate the reader lock request with a particular local counter 302. The reader thread acquiring the semaphore 124 obtains the address or location associated with the corresponding local counter 302.

The reader thread acquiring the semaphore increments the read count in the local counter (block 404). For example, the reader thread attempting to acquire the semaphore 124 uses a “lock xadd” instruction or similar instruction for an atomic add operation to increment the reader count 306 associated with the corresponding local counter 302. The lock prefix provides atomicity by preventing other threads from accessing the memory location associated with the reader count 306 while the increment operation is in progress. The reader thread acquiring the semaphore 124 also obtains the current (or old) value of the local counter 302, including the writer-presence bit 308.

The reader thread then determines whether the writer-presence bit is set (block 406). In particular, the reader thread acquiring the semaphore 124 checks the return value to determine if the writer-presence bit 308 is set. In response to the writer-presence bit not being set (e.g., a “no” determination at block 406), the reader thread returns with the lock acquired (block 408). For example, if the writer-presence bit 308 is not set, the reader thread acquiring the semaphore 124 returns with the lock acquired and enables preemption. The reader thread then accesses the shared data associated with the read request.

In response to the writer bit being set (e.g., a “yes” determination at block 406), the reader thread decrements the reader count, returns with a lock acquisition failure, and adds the reader thread to the global wait queue (block 410). For example, if the writer-presence bit 308 is set, the reader thread acquiring the semaphore 124 decrements the reader count 306 associated with the corresponding local counter 302 to remove the previously added increment value (e.g., from block 404). The reader thread also returns with an indication of a lock acquisition failure and adds the reader thread to the global wait queue 314 to acquire the semaphore 124 later. After acquiring a wait-queue lock, the reader thread checks the writer-presence bit 308 again to determine if the writer-presence bit 308 is cleared. If the writer-presence bit 308 is cleared, the reader thread releases the wait-queue lock and attempts to acquire the semaphore 124 again. If the try lock on the local counter 302 is unsuccessful, the semaphore adds an entry to the global wait queue 314 and releases the wait queue lock. The reader thread in the global wait queue 314 waits until it is woken up to try procedure 400 again.

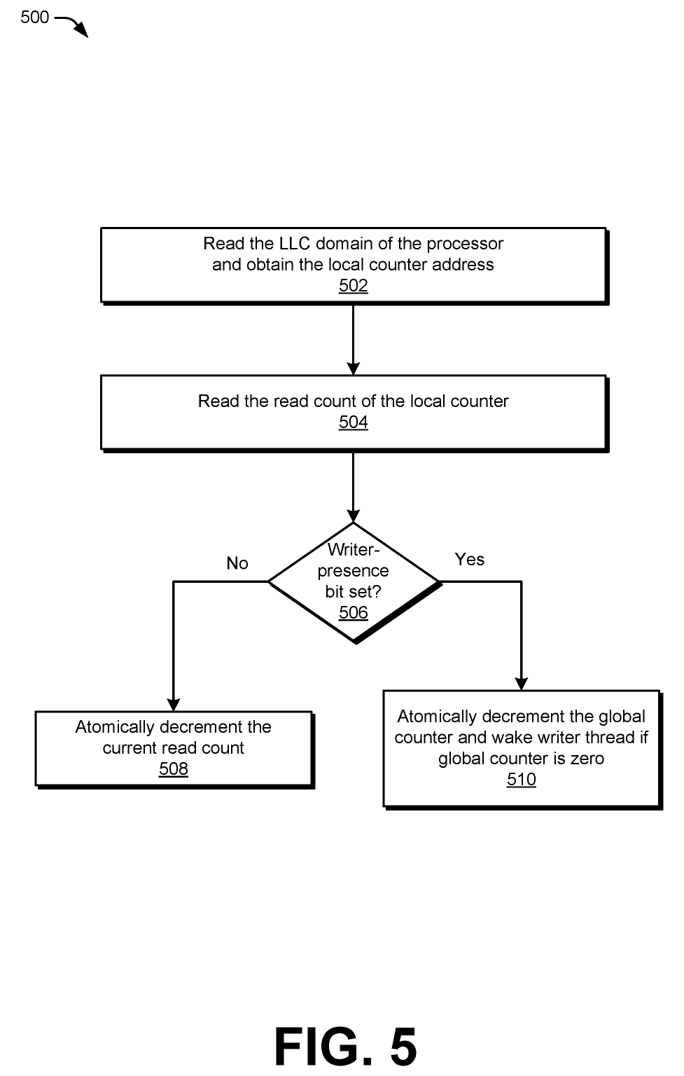

FIG. 5 depicts an example procedure 500 for a reader lock release to implement an LLC-aware reader-writer semaphore in accordance with one or more implementations.

For a reader thread to release the lock state variable, a semaphore reads the LLC domain of the processor and obtains the local counter address (block 502). For example, semaphore 124 determines an LLC or NUMA domain associated with the reader thread to associate the reader lock release with a particular local counter 302. The semaphore 124 obtains the address or location associated with the corresponding local counter 302. Prior to checking the LLC or NUMA domain, preemption is disabled to prevent the reader thread from migrating to a different chiplet or processor associated with a different domain.

The reader thread reads the read count in the local counter (block 504). For example, the reader thread uses a “up_read” function or a similar semaphore-release operation to obtain the reader count 306 associated with the corresponding local counter 302. The reader thread then determines whether the writer-presence bit is set (block 506). For example, the reader thread checks the return value to determine if the writer-presence bit 308 is set. In response to the writer-presence bit 308 not being set (e.g., a “no” determination at block 506), the reader thread decrements the current local read count (block 508). For example, if the writer-presence bit 308 is not set, the reader thread compares and exchanges (e.g., using a “cmpxchg” instruction or similar instruction) the current read counter 306 with a new value to decrement the reader count 306 of the local counter 302. If the decrement is successful, the reader thread enables preemption. If the decrement is unsuccessful, the reader thread determines whether the writer-presence bit 308 is set in the corresponding local counter 302. If the writer-presence bit 308 is not set, the reader thread tries to decrement the reader counter 306 again.

In response to the writer bit being set (e.g., a “yes” determination at block 506), the reader thread decrements the global counter and wakes the writer thread if the global counter value is zero (block 510). For example, if the writer-presence bit 308 is set, reader thread decrements the global reader count 310 (e.g., using a “lock xadd” instruction or similar instruction) of the global counter 304, wakes the writer thread if the global counter value is zero, and enables preemption.

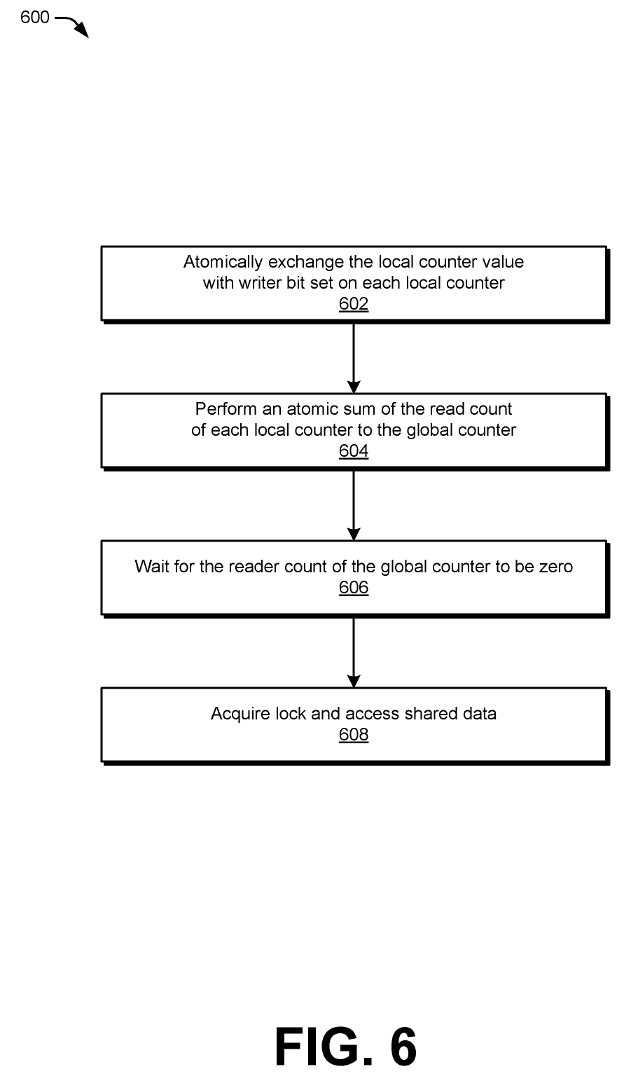

FIG. 6 depicts an example procedure 600 for a writer lock acquisition to implement an LLC-aware reader-writer semaphore in accordance with one or more implementations.

For a writer thread to acquire the semaphore 124, the writer thread acquiring the semaphore 124 adds a “one” value or positive flag to the writer-blocked state 312 and checks the previous or old writer-blocked value. If the return value is zero or represents “false,” the writer thread acquiring the semaphore 124 proceeds to perform procedure 600. If the return value is one or represents “true,” the writer thread acquires a wait queue lock, adds a “one” value or “true” flag to the writer-block state 312 and checks the previous or old writer-blocked value. The writer thread also adds an entry to the global wait queue 314. The wait queue lock is then released. The writer thread then waits until the try lock is successful.

The writer thread reads and sets the writer-presence bit on each local counter (block 602). For example, the writer thread reads and sets the writer-presence bit 308 on each local counter 302 to indicate the presence of a writer thread. An atomic sum of the read count of each local counters is then performed and provided to the read count of the global counter (block 604). For example, the writer thread obtains the reader count 306 associated with each local counter 302 and performs an instruction which atomically exchanges the local counter value with a value of one (e.g., writer-presence set) and accumulates the local counter value into a temporary location (e.g., a 64-bit location “sum”), which accumulated sum from each local counter is then atomically added to the global reader count 310 of the global counter 304.

The writer thread then waits for the global counter to be zero (block 606). For example, the writer thread waits for the existing reader threads with a lock to finish reading data. The writer thread returns with the lock and the writer thread accesses the shared data (block 608). The writer thread returns with an indication of a lock acquisition. The writer thread then accesses the shared data.

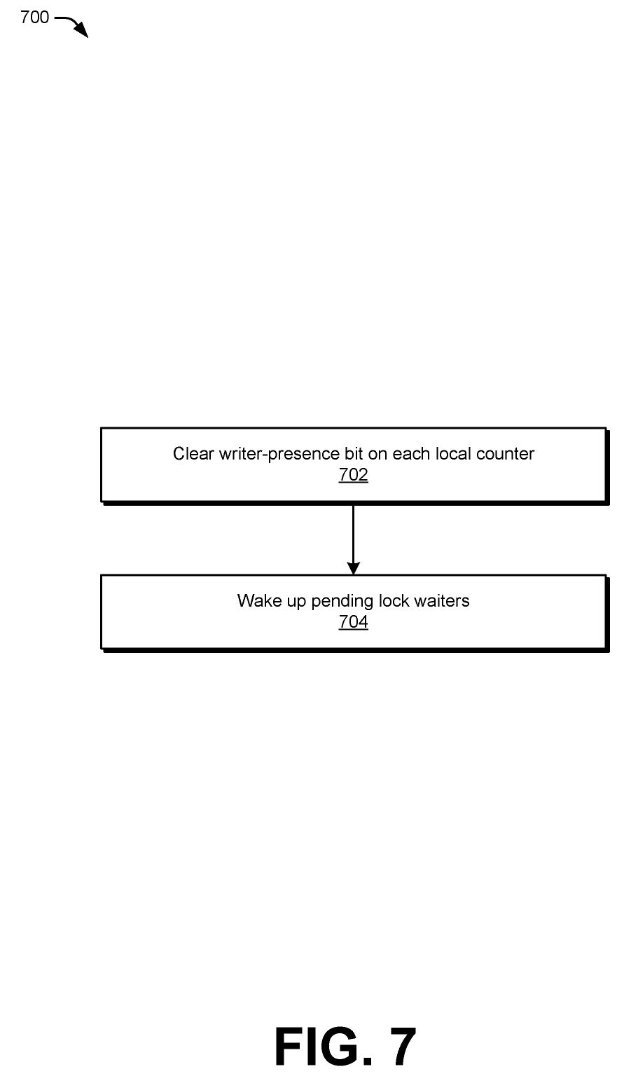

FIG. 7 depicts an example procedure 700 for a writer lock release to implement an LLC-aware reader-writer semaphore in accordance with one or more implementations.

For a writer thread to release a lock state variable, the writer-presence bit is atomically cleared on each local counter (block 702). For example, in response to the writer thread releasing its lock, the writer thread atomically clears the writer-presence bit 308 on each local counter 302 and clears the writer-blocked state 312. Pending lock waiters are then awakened (block 704). For example, the writer thread wakes any reader threads or writer threads in a wait queue to make progress according to procedure 400 or 600, respectively.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 202, the processor 204, the memory system 206 having the volatile memory 208 and the non-volatile memory 210, the execution units 212, the load-store units 214, the fetch units 216, the cache system 218, and the semaphore 124) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or processor. Examples of non-transitory computer-readable storage mediums include read-only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A processor comprising:
a semaphore associated with a shared cache level of a hierarchy of one or more cache levels, the semaphore including:
multiple local counters, each local counter associated with a domain of multiple domains and includes a reader counter and a writer-presence bit; and
a global counter that includes a global reader counter.

2. The processor of claim 1, wherein, in response to receiving a read lock request from a reader thread, the semaphore is configured to:
disable preemption to prevent the reader thread from migrating to a different domain;
determine the domain of the processor associated with the reader thread;
increment the reader counter of the local counter corresponding to the domain; and
in response to the writer-presence bit of the local counter not being set, acquire a read lock for the reader thread.

3. The processor of claim 2, wherein the semaphore is further configured to:
in response to the writer-presence bit of the local counter being set, decrement the reader counter of the local counter;
return a read lock failure to the reader thread; and
add the reader thread to a global wait queue of the semaphore.

4. The processor of claim 2, wherein, in response to receiving a read lock release request from the reader thread, the semaphore is configured to:
read the reader counter of the local counter corresponding to the domain; and
in response to the writer-presence bit of the local counter not being set, decrement the reader counter of the local counter.

5. The processor of claim 4, wherein the semaphore is further configured to:
in response to the writer-presence bit of the local counter being set, decrement the global reader counter of the global counter, wake a waiting writer thread if the global reader counter becomes zero, and enable preemption.

6. The processor of claim 1, wherein the semaphore is further configured to, in response to receiving a write lock request from a writer thread, set a writer-blocked state to indicate a writer thread as a first writer thread contending for a write lock.

7. The processor of claim 6, wherein, in response to receiving the write lock request from the first writer thread, the semaphore is configured to:
set the writer-presence bit of the multiple local counters;
set the global reader counter of the global counter to a sum of the reader counter of the multiple local counters; and
in response to the global reader counter of the global counter being equal to zero, acquire the write lock for the first writer thread.

8. The processor of claim 7, wherein the semaphore is further configured to assign subsequent reader threads and subsequent writer threads to a global wait queue of the semaphore.

9. The processor of claim 7, wherein the semaphore is further configured to:
in response to the global reader counter not being equal to zero, wait for the global reader counter to be equal to zero.

10. The processor of claim 7, wherein, in response to receiving a writer lock release request from the first writer thread, the semaphore is configured to:
atomically clear the writer-presence bit of the multiple local counters;
clear a writer-blocked state; and
awake pending lock waiters in a global wait queue.

11. The processor of claim 1, wherein setting of the writer-presence bit indicates a presence of a waiting or active writer thread.

12. A method comprising:
receiving, by a semaphore associated with a shared cache level of a hierarchy of one or more cache levels, a read lock request from a reader thread;
determining, by the semaphore, a domain of multiple domains of a processor associated with the reader thread;
incrementing, by the semaphore, a reader counter of a local counter of multiple local counters corresponding to the domain; and
in response to a writer-presence bit of the local counter not being set, acquiring a read lock for the reader thread.

13. The method of claim 12, wherein the method further comprises:
in response to receiving the read lock request from the reader thread, disabling preemption to prevent the reader thread from migrating to a different domain;
in response to the writer-presence bit of the local counter being set, decrementing the reader counter of the local counter;
returning a read lock failure to the reader thread; and
adding the reader thread to a global wait queue of the semaphore.

14. The method of claim 12, wherein the method further comprises:
in response to receiving a read lock release request from the reader thread, reading the reader counter of the local counter corresponding to the domain; and
in response to the writer-presence bit of the local counter not being set, decrementing the reader counter of the local counter.

15. The method of claim 14, wherein the method further comprises:
in response to the writer-presence bit of the local counter being set, decrementing a global reader counter of a global counter of the semaphore, waking a writer thread if the global reader counter becomes zero, and enabling preemption.

16. A method comprising:
in response to receiving a write lock request from a writer thread, setting, by a semaphore associated with a shared cache level of a hierarchy of one or more cache levels, a writer-blocked state to indicate the writer thread as a first writer thread contending for the writer lock; and
assigning subsequent reader threads and subsequent writer threads to a global wait queue of the semaphore.

17. The method of claim 16, wherein the method further comprises:
in response to receiving the write lock request from the first writer thread, setting, by the semaphore , a writer-presence bit of multiple local counters, each local counter associated with a domain of multiple domains of the shared cache level;
setting, by the semaphore, a global reader counter of a global counter of the semaphore to a sum of a reader counter of the multiple local counters; and
in response to the global reader counter of the global counter being equal to zero, acquiring, by the semaphore, the write lock for the first writer thread.

18. The method of claim 17, wherein the method further comprises:
in response to the global reader counter not being equal to zero, waiting for the global reader counter to be equal to zero.

19. The method of claim 17, wherein the method further comprises:
in response to receiving a writer lock release request from the first writer thread, atomically clearing the writer-presence bit of the multiple local counters;
clearing a writer-blocked state of the semaphore; and
awaking pending lock waiters in a global wait queue.

20. The method of claim 17, wherein setting of the writer-presence bit indicates a presence of a waiting or active writer thread.
